(19) United States
(12) Patent Application Publication
(10) Pub. No.: US 2018/0028964 A1
(43) Pub. Date: Feb. 1, 2018

(54) Activated Carbon Bed For Use With A Wet Scrubber System

(71) Applicant: General Electric Company, Schenectady, NY (US)

(72) Inventors: Ghazale Hosseinzadeh Attar Nilsson, Vaxjo (SE); Anders Ljungberg, Vaxjo (SE); Daniel Per Niklas Persson, Vaxjo (SE); Erland Leif Klintenheim, Vaxjo (SE)

(21) Appl. No.: 15/223,341

(22) Filed: Jul. 29, 2016

(51) Int. Cl. B01D 53/18; B01D 53/14; B01D 53/04

(52) U.S. Cl. CPC B01D 53/18; B01D 53/0462; B01D 53/0438; B01D 53/1425; B01D 2258/0283; B01D 2252/103; B01D 2253/102; B01D 2257/00

(57) ABSTRACT

The present application provides a wet scrubber system for treating a flow of flue gases with dioxins therein with a flow of a fluid. The wet scrubber system may include a column member, a packed bed positioned within the column member, and an activated carbon filter bed system in communication with the column member such that at least a portion of the flow of the fluid passes through the activated carbon filter bed system to remove the dioxins therein before being recirculated back to the column member.

### TECHNICAL FIELD

The present application and the resultant patent relate generally to combustion plant emissions control systems and more particularly relate to a activated carbon bed system for removal of dioxins in flue gases flowing through a wet scrubber system.

### BACKGROUND OF THE INVENTION

Waste-to-energy combustion plants and the like often include a wet scrubber system for the removal of gaseous pollutants and recovery of condensation heat so as to improve overall plant efficiency. Specifically, a portion of the heat of the hot flue gases produced in the combustion process may be recovered and applied for useful work. A common means of removing pollutions and recovering such heat is through a packed bed scrubber and the like. Generally described, the hot flue gases may enter the scrubber at the bottom thereof and rise through a packed bed while a fluid flows downward therethrough so as to remove gaseous pollutants and to exchange heat with the flue gases. The packed bed is often a random filling or a structured bed made out of a thermoplastic such as polypropylene. The now warmed fluid then may be applied for any useful purpose.

One of the drawbacks with the use of a packed bed wet scrubber is that the polypropylene or other type of thermoplastic or other type of packing material may have a tendency to accumulate dioxins (chlorinated dibenzo(p)-dioxin and furan compounds) formed in the combustion process. Specifically, dioxins are heavy aromatic molecules that have a great affinity to organic surfaces such as polypropylene and thus may be absorbed therein. The accumulated dioxins, however, may be released back into the flue gas steam if the operating temperatures or other types of operating conditions change. The increase in the dioxin content of the flue gas stream is known as the “memory effect.”

The memory effect may be prevented or at least reduced if the dioxins can be bound to the thermoplastic. One binding method is to add activated carbon to the thermoplastic matrix of the packed bed. Although effective, this method generally requires the complete replacement of all of the packing at a regular interval depending upon the dioxin load. The addition of the activated carbon also adds to the overall material costs.

### SUMMARY OF THE INVENTION

The present application and the resultant patent thus provide a wet scrubber system for treating a flow of flue gases with dioxins therein with a flow of a fluid. The wet scrubber system may include a column member, a packed bed positioned within the column member, and an activated carbon filter bed system in communication with the column member such that at least a portion of the flow of the fluid passes through the activated carbon filter bed system to remove the dioxins therein before being recirculated back to the column member.

The present application and the resultant patent further provide a method of removing dioxins from a flow of flue gases in a wet scrubber system. The method may include the steps of flowing the flue gases through a packed bed of the wet scrubber system, flowing a fluid through the packed bed of the wet scrubber system, dissolving dioxins in the flue gases in the fluid, flowing the fluid through an activated carbon filter bed to remove the dioxins therein, and recirculating the fluid back to the packed bed.

The present application and the resultant patent further provide a packed bed condensing system for cooling a flow of flue gases with dioxins therein with a flow of a cooling fluid. The packed bed condensing system may include a column member, a polypropylene packed bed positioned within the column member with the flow of flue gases and the flow of the cooling fluid passing through the packed bed, and an activated carbon filter bed system in communication with the column member such that at least a portion of the flow of the cooling fluid passes through the activated carbon filter bed system to remove the dioxins therein before being recirculated back to the packed bed of the column member.

These and other features and improvements of the present application and resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of an example of a wet scrubber system.

FIG. 2 is a schematic diagram of a wet scrubber system as may be described herein.

FIG. 3 is a schematic diagram of an alternative embodiment of a wet scrubber system as may be described herein.

### DETAILED DESCRIPTION

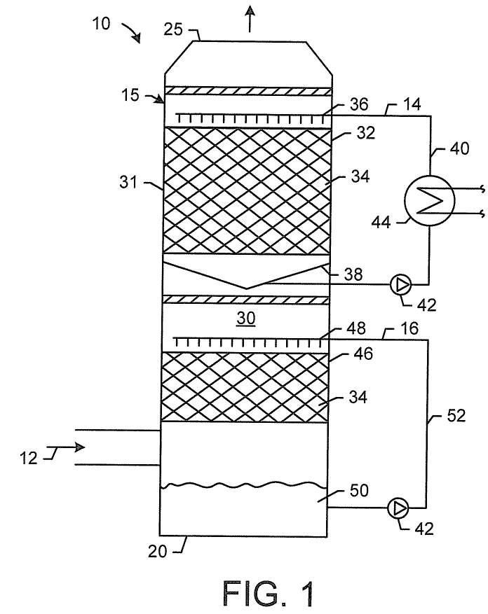

Referring now to the drawings, in which like numerals refer to like elements throughout the several views, FIG. 1 shows an example of a known wet scrubber system 10. The wet scrubber system 10 may remove gaseous pollutants and exchange heat between a flow of flue gases 12 and a flow of a fluid 14. The fluid 14 may be water or any type of conventional fluid flow.

Generally described, the wet scrubber system 10 may include an elongated column member 15. The column member 15 may be generally cylindrical in shape but could be rectangular, square, and the like. The column member 15 may have a lower end 20, an upper end 25, and a central cavity 30 therebetween. One or more packed beds 31 may be positioned within the central cavity 30 forming an upper condensing bed 32. Specifically, an upper scrubber packed bed 32 may be positioned within the central cavity 30. The upper condensing packed bed 32 may be made out of any suitable type of packing materials 34 such as polypropylene and other types of thermoplastics, arranged as a random filling or a structured bed. Combinations of different types of packing materials also may be used herein.

An upper liquid distributor 36 may be positioned at the upper end 25 of the column member 15 above the upper condensing packed bed 32. The upper liquid distributor 36 may be any type of conventional spray or mist delivery devices used to deliver the cooling fluid 14 to the upper condensing packed bed 32. An upper liquid collector 38 may be positioned beneath the upper condensing packed bed 32. An upper recirculation line 40 may extend from the upper liquid collector 38 back to the upper liquid distributor 36 for at least a portion of the cooling fluid flow 14. One or more pumps 42 or other types of fluid moving devices may be positioned on the recirculation line 40. A heat exchanger 44 may be positioned on the recirculation line 40 so as to recover a portion of the heat in the flow of flue gases 12. The recovered heat may be applied to any useful purpose.

A lower scrubber packed bed 46 may be positioned within the central cavity 30 beneath the upper condensing packed bed 32. The primary purpose of the lower scrubber packed bed 46 is to remove gaseous pollutants, i.e., HCl, NH₃, and the like. Some cooling also may take place until the flue gases 12 become fully saturated. The lower scrubber packed bed 46 may be considered a “polishing scrubber” to reduce the remaining pollutants. The lower scrubber packed bed 46 may be made out of any suitable type of packing materials 34 such as polypropylene and other types of thermoplastics arranged as a random filling or a structured bed. Combinations of different types of packing materials also may be used herein. A lower liquid distributor 48 may be positioned above the lower scrubber packed bed 46. The lower liquid distributor 48 may be any type of conventional spray or mist delivery devices used to deliver a fluid flow 16 to the lower scrubber packed bed 46. A lower liquid collector 50 may be positioned beneath the lower scrubber packed bed 46. A lower recirculation line 52 may extend from the lower liquid collector 50 back to the lower liquid distributor 48 for at least a portion of the fluid flow 16. One or more pumps 42 or other types of fluid moving devices may be positioned on the recirculation line 52. Other components and other configurations may be used herein.

The wet scrubber system 10 also may include a number of valves, flow meters, and other types of flow regulating components as may be conventionally used. The wet scrubber system 10 described herein is for the purpose of example only. Many other and different types of wet scrubber systems 10 and components thereof may be used in any suitable size, shape, or configuration.

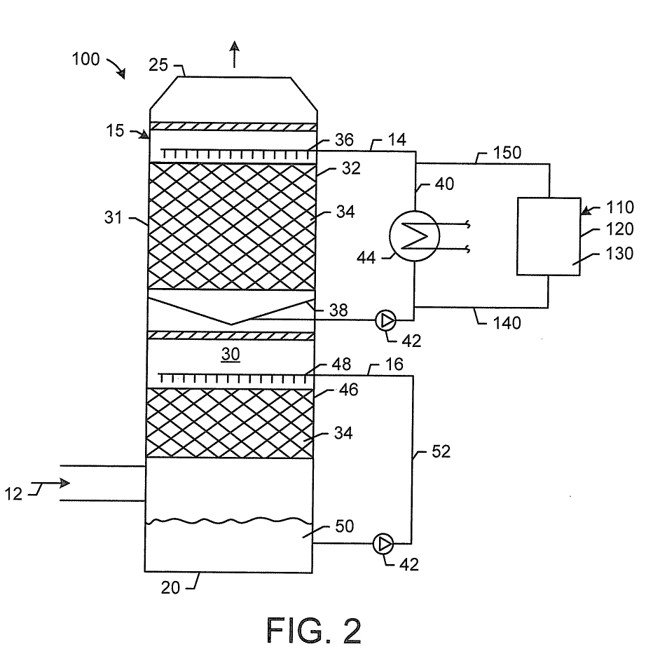

FIG. 2 shows an example of a wet scrubber system 100 as may be described herein. The wet scrubber system 100 largely may include components of the wet scrubber system 10 described above in whole or in part. Other components and other configurations may be used herein.

The wet scrubber system 100 also may include an activated carbon filter bed system 110. The activated carbon filter bed system 110 may include an activated carbon filter bed 120. The activated carbon filter bed 120 may have any suitable size, shape, or configuration. The activated carbon filter bed 120 may have a volume of an activated carbon material 130 therein. The activated carbon 130 may be of conventional type and/or grade. Any suitable volume of the activated carbon 130 may be used herein. The activated carbon 130 may be replaceable. Other components and other configurations may be used herein.

The activated carbon filter bed 120 may be in communication with the upper condensing packed bed 32 of the column member 15 via a slipstream line 140. The slipstream line 140 may extend from the upper recirculation line 40 or elsewhere to the activated carbon filter bed 120. The activated carbon filter bed system 110 also may include a return line 150. The return line 150 may extend from the activated carbon filter bed 120 to the upper recirculation line 40 and/or elsewhere in communication with the column member 15 and the upper condensing packed bed 32. The activated carbon filter bed system 110 also may include any number of the valves, the flow meters, and other types of flow control devices. Other components and other configurations also may be used herein.

In use, the cooling fluid 14 from the upper liquid distributor 40 flows downward into the upper condensing packed bed 32 within the central cavity 30 of the column member 15 as the hot flue gases 12 rise therein through the lower scrubber packed bed 46 and into the upper condensing packed bed 32. The cooling fluid 14 exchanges heat with the hot flue gases 12. Dioxins in either and/or both the flue gases 12 and/or the polypropylene of the upper condensing packed bed 32 may be dissolved in the cooling fluid 14 as the fluid drops into the upper liquid collector 38 and is forwarded to the upper recirculation line 40. Dissolving the dioxins into the cooling fluid flow 14 may eliminate or at least reduce the return of the dioxins from the polypropylene of the upper condensing packed bed 32 to the flue gases 12 in the memory effect.

Specifically, a slipstream from the main recirculation flow of the cooling fluid 14 may be diverted to the slipstream line 140 and the activated carbon filter bed 120. Any dioxins in the recirculated cooling fluid 14 may be trapped within the activated carbon 130 before being returned to the upper condensing packed bed 32 of the column member 15 via the return line 150. The volume of the diverted slipstream of the cooling fluid 14 should be sufficient to effectively prevent or at least reduce the memory effect in the upper condensing packed bed 32.

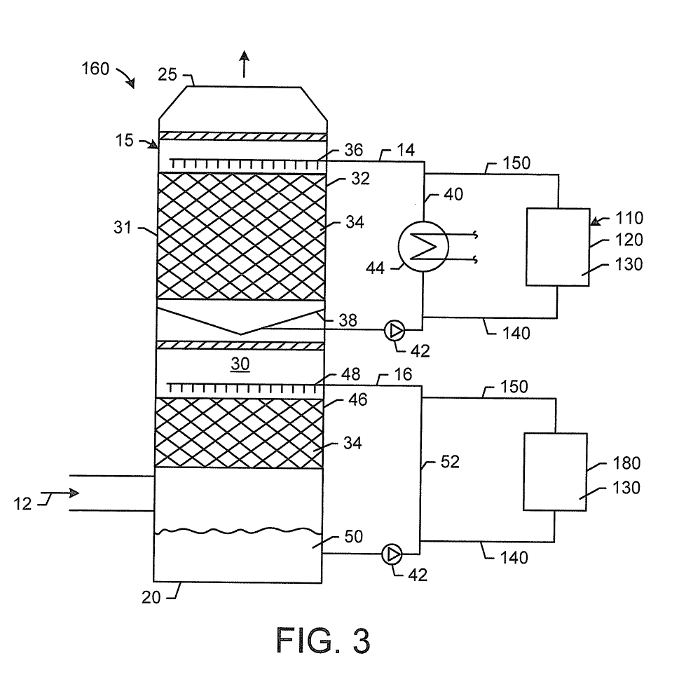

FIG. 3 shows a further embodiment of an activated carbon filter bed system 160 as may be described herein. In this example, the activated carbon filter bed system 160 may include an upper activated carbon bed 170 and a lower activated carbon bed 180. The upper activated carbon bed 170 may function as described above. The lower activated carbon bed 180 may be in communication with the lower scrubber packed bed 46 via the lower recirculation line 52. The activated carbon beds thus may in communication with the upper condensing packed bed 32, the lower scrubber packed bed 46, and/or both. Other components and other configurations may be used herein.

The activated carbon filter bed system 110 thus may be less expensive as compared to binding the activated carbon into the packing material 34. Moreover, replacement of the activated carbon in the activated carbon filter bed 120 also may be simplified as compared to replacing all of the packing material itself. Significantly, the activated carbon filter bed system 110 need only be employed when the overall dioxin levels exceed a predetermined level as opposed to continuous operation. The activated carbon filter bed system 110 may be original equipment or part of a retrofit.

It should be apparent that the foregoing relates only to certain embodiments of the present application and resultant patent. Numerous changes and modifications may be made herein by one of ordinary skill in the art without departing from the general spirit and scope of the invention as defined by the following claims and the equivalents thereof.

We claim:

1. A wet scrubber system for treating a flow of flue gases with dioxins therein with a flow of a fluid, comprising:
a column member;
a packed bed positioned within the column member; and
an activated carbon filter bed system in communication with the column member such that at least a portion of the flow of the fluid passes through the activated carbon filter bed system to remove the dioxins therein before being recirculated back to the column member.

2. The wet scrubber system of claim 1, wherein the packed bed comprises an upper condensing packed bed.

3. The wet scrubber system of claim 2, wherein the upper condensing packed bed comprises an upper liquid distributor.

4. The wet scrubber system of claim 3, wherein the upper condensing packed bed comprises an upper liquid collector.

5. The wet scrubber system of claim 4, further comprising an upper recirculation line extending between the upper liquid collector and the upper liquid distributor.

6. The wet scrubber system of claim 5, wherein the upper recirculation line comprises a pump thereon.

7. The wet scrubber system of claim 5, wherein the upper recirculation line comprises a heat exchanger thereon.

8. The wet scrubber system of claim 1, wherein the packed bed comprises a lower scrubbing packed bed.

9. The wet scrubber system of claim 8, wherein the lower scrubbing packed bed comprises a lower liquid distributor, a lower liquid collector, and a lower recirculation line extending therebetween.

10. The wet scrubber system of claim 1, wherein the packed bed comprises a packing material therein.

11. The wet scrubber system of claim 10, wherein the packing material comprises a polypropylene.

12. The wet scrubber system of claim 1, wherein the activated carbon filter bed system comprises an activated carbon filter bed with an active carbon material therein.

13. The wet scrubber system of claim 12, wherein the activated carbon filter bed system comprises a slipstream line and a return line in communication with the activated carbon filter bed and the column member.

14. The wet scrubber system of claim 1, wherein the activated carbon filter bed system comprises an upper activated carbon filter bed and a lower activated carbon filter bed.

15. A method of removing dioxins from a flow of flue gases in a wet scrubber system, comprising:
flowing the flue gases through a packed bed of the wet scrubber system;
flowing a fluid through the packed bed of the wet scrubber system;
dissolving dioxins in the flue gases in the fluid;
flowing at least a portion of the fluid through an activated carbon filter bed to remove the dioxins therein; and
recirculating the portion of the fluid back to the packed bed.

16. A packed bed condensing system for cooling a flow of flue gases with dioxins therein with a flow of a cooling fluid, comprising:
a column member;
a packed bed positioned within the column member;
the flow of flue gases and the flow of the cooling fluid passing through the packed bed;
the packed bed comprising a polypropylene packing material; and
an activated carbon filter bed system in communication with the column member such that at least a portion of the flow of the cooling fluid passes through the activated carbon filter bed system to remove the dioxins therein before being recirculated back to the packed bed of the column member.

17. The packed bed condensing system of claim 16, wherein the packed bed comprises an upper condensing packed bed and a lower scrubbing packed bed.

18. The packed bed condensing system of claim 16, wherein the activated carbon filter bed system comprises an activated carbon filter bed with an active carbon material therein.

19. The packed bed condensing system of claim 16, wherein the activated carbon filter bed system comprises a slipstream line and a return line in communication with the activated carbon filter bed and the packed bed.

20. The packed bed condensing system of claim 16, wherein the activated carbon filter bed system comprises an upper activated carbon filter bed and a lower activated carbon filter bed.
